(19) United States
(12) Patent Application Publication
(10) Pub. No.: US 2024/0074419 A1
(43) Pub. Date: Mar. 7, 2024

(54) Fishing Tool

(71) Applicant: Gary Bennis, Eau Claire, WI (US)

(72) Inventors: Gary Bennis, Eau Claire, WI (US); Mason Beissel, Cannon Falls, MN (US)

(73) Assignee: Gary Bennis, Eau Claire, WI (US)

(21) Appl. No.: 18/493,321

(22) Filed: Oct. 24, 2023

Related U.S. Application Data
(60) Provisional application No. 63/374,680, filed on Sep. 6, 2022.

(51) Int. Cl. A01K 87/00

(52) U.S. Cl. CPC A01K 87/008

(57) ABSTRACT

The invention relates to a multipurpose fishing tool that includes a clamping portion to clip the fishing tool onto a fishing rod; a line cutting portion; a line trimming portion; a hook sharpening portion; an eyelet cleaning portion; and one or more hook eyelet threading portions. The clamping portion; the line cutting portion, the line trimming portion, the hook sharpening portion, the eyelet cleaning portion, and the hook eyelet threading portion are each a different portion from the other.

### TECHNICAL FIELD OF THE INVENTION

The technical field of the invention relates to fishing and in particular to a fishing tool for threading fishing hook eyelets, cleaning fishing eyelets, cutting and trimming fishing line and sharpening hooks while being clamped to a fishing rod or while holding in the fisherman's hand.

### BACKGROUND OF THE INVENTION

Threading fishing line onto a hook such as part of a lure, fly, spinner, or bait hook, can be a difficult process, particularly for people with limited fishing experience or eyesight or physical limitations that make threading a small piece of line into the small eyelet of a lure or hook difficult. The small diameters of fishing line and lure that are desirable for successful fishing often make it difficult to thread the line into the lure or hook. The eyelet's of a fishing lure and hooks may be small and it can be challenging for the angler to insert the fishing line into the eyelet. This may be even more challenging during cold, windy conditions, or on a moving or rocking boat. There have been attempts to provide devices that can guide the fishing line through an eyelet of a fishing hook, such as described in U.S. Pat. Nos. 4,029,346 and 4,188,052, which describe devices for use in guiding a fishing line though a fishing hook. Anglers recognize that threading a thin, flexible line through the small aperture of a hook eyelet is difficult, especially on a moving boat, when it is windy outside, or under low light or poor weather conditions. Consequently, anglers may not be able to fully enjoy their sport or hobby due to the challenges of inserting lines through an eyelet and tying knots. The difficulty with threading is compounded by any lack of visual acuity or digital dexterity.

In fact, it is known that fish and expensive lures are regularly lost by anglers as a consequence of failing to retie lures or hooks attached to a line that has nicks caused by underwater objects or teeth from previous catches. Frequent threading and retying results in fewer lost lures and fish, but because of the difficulty of threading and retying fishing line into lures and hooks, most fishermen only undertake the task when it is obviously necessary.

The physical act of threading a fishing line though a hook eyelet also may be challenging. When a fine line is to be threaded through a small hole, the line must be held by fingertips or pliers near the end of the line, and the line's tip fed through the small aperture by the adjacent portion that is held by the fingertips. Once the tip extends through the aperture, the rest of the line follows in a carefully executed maneuver that involves spreading the fingertips while pushing along the axis of the line. This well-known test of a person's fine motor skills becomes more difficult with age, but it is those of retired age who are more likely to engage in leisure activities that include fishing, which is accompanied by threading the line through the eyelet.

Conventional devices attempt to assist people with threading needles and hooks, but most such devices are costly, complicated, ineffective and/or inconvenient. Two commercial products that perform a similar function are known. One device is the “Quik Tye” brand product based on U.S. Pat. No. 5,383,695 to Couper. The Couper device uses a scissor/pivot motion to secure the hook's eyelet between two rigid, parallel planar members with a fixed space between the ends of the members to aid in holding the hook in place. The Couper device is for tying small lures to tippets used in fly fishing. The device may damage the fishing line upon removal from the tool, and its use includes a motion that is awkward. Furthermore, the device's planar members may not pivot freely if dirt gets between them. Also, the Couper device may not facilitate consistent knot-tying because the line may unintentionally come out of the fixed pockets in the ends of the planar members.

Another prior art device is marketed under the trademark “20/20 Magnetic Tippet Threader” by Tight-Line-Enterprises which uses a magnet to hold a fly hook in position for threading. This device requires the user to place the line into a narrow channel, which may be a challenge for many users. The geometry of the device limits its use with larger-bodied lures. Heavier lures, which are more frequently used in fishing styles other than fly fishing, may not be adequately held in place by the magnet.

U.S. Pat. No. 10,212,925 discloses a fishing tool for threading an eyelet of a fishing hook with a fishing line. FIG. 16 of the instant specification corresponds to FIG. 1A of the '925 patent in which the fishing tool 10 includes a pair of deformable, semi-circular jaws 11, 12 that partially enclose an attachment cavity 14 that is temporarily deformable from its normal positions to allow entry and capture of a fishing rod. The tool 10 includes a portion 13 for inserting the eyelets of a fishing hook. The deformable jaws 11, 12 are not a hinge as that term is commonly used.

There appears to be a continuing need for a device that can be used easily by an angler to guide a fishing line through the eyelet of a fishing hook and to tie the fishing line to the fishing hook as well as easily clamp the tool to the fishing rod and easily remove the tool from the fishing rod.

### SUMMARY OF THE INVENTION

In one general aspect, the invention relates to a multipurpose fishing tool that includes a clamping portion to clip the fishing tool onto a fishing rod; a line cutting portion; a line trimming portion; a hook sharpening portion; an eyelet cleaning portion; and one or more hook eyelet threading portions. The clamping portion; the line cutting portion, the line trimming portion, the hook sharpening portion, the eyelet cleaning portion, and the hook eyelet threading portion are each a different portion from the other.

Embodiments of the multipurpose fishing tool may include one or more of the following features. For example, the hook sharpening portion may include a sharpening surface. The sharpening surface further include a groove.

The hook eyelet cleaning portion may include a prong or needle having an end configured to be inserted within an eyelet of a hook. At least a portion of the prong or needle may be positioned within an enclosure.

The line cutting portion may include a line cutting blade. The line cutting portion may include a groove enclosed on at least two sides and the line cutting blade is positioned within the groove, whereby a user of the fishing tool is protected from injury by the line cutting blade.

The fishing tool may be in the form of a first half and a second half joined together by a hinge mechanism.

The eyelet cleaning portion and the hook sharpening portion may be positioned on the first half and the line cutting portion may be positioned on the second half.

The line trimming portion may include a block and a line trimming blade and the block is positioned on one of the first half and the second half and the line trimming blade is positioned on the other of the first half and the second half.

The first half may include a first upper portion, a first middle portion and a first handle; the second half may include a second upper portion, a second middle portion and a second handle; and the line trimming portion may include a block and a line trimming blade and the block is positioned on one of the first handle and the second handle and the line trimming blade is positioned on the other of the first handle and the second handle. In this manner, moving the first handle in the direction of the second handle moves the line trimming blade in the direction of the block such that a fishing line positioned between the blade and the block will be cut when the line trimming blade is pressed against the block.

The first half may include a first upper portion with a first inner surface, a first middle portion and a first handle; the second half may include a second upper portion with a second inner surface, a second middle portion and a second handle; and the fishing hook includes one or more hook eyelet threading portions, wherein each eyelet portion comprises a first channel defined by a first opening at one end and a second opening at the opposite end and a second channel passing between a third opening and a closed end, wherein the first channel and the second channel intersect. A portion of the first channel and a portion of the second channel is formed in the first upper portion and a portion of the first channel and a portion of the second channel is formed in the second upper portion such that the first and second channels are formed when the first inner surface of the first upper portion and the second inner surface of the second upper portion are in contact.

The first half may include a first upper portion with a first inner surface, a first middle portion with a third inner surface and a first handle, wherein the third inner surface is concave and forms a semicircle; the second half may include a second upper portion with a second inner surface, a second middle portion with a fourth inner surface and a second handle wherein the fourth inner surface is concave and forms a semicircle; and when the first inner surface is in contact with the second inner surface the third inner surface and the fourth inner surface form and define a lengthwise channel passing from a first opening at a first end of the fishing tool to a second opening at a second, opposite end of the fishing tool, whereby the lengthwise channel is configured to retain a fishing rod or a fishing rod handle. The lengthwise channel may have an oval cross-section.

In the multipurpose fishing tool, the third inner surface may include a first compliant pad and the fourth inner surface may include a second compliant pad.

In another general aspect, the multipurpose fishing tool has a butterfly clip configured to clip onto a fishing rod and includes at least two of the following: a line cutting portion; a line trimming portion; a hook sharpening portion; an eyelet cleaning portion; and one or more hook eyelet threading portions. The line cutting portion, the line trimming portion, the hook sharpening portion, the eyelet cleaning portion, and the one or more hook eyelet threading portions are each a different portion from the other.

Embodiments of the multipurpose fishing tool may include one or more of the following features.

The hook eyelet cleaning portion may include a prong or needle having an end configured to be inserted within an eyelet of a hook and at least a portion of the prong or needle is positioned within an enclosure. The line cutting portion may include a groove enclosed on at least two sides and a line cutting blade is positioned within the groove, whereby a user of the fishing tool is protected from injury by the line cutting blade. The hook sharpening portion may include a sharpening surface and the sharpening surface includes at least one groove. The hook eyelet cleaning portion may include a prong or needle having an end configured to be inserted within an eyelet of a hook.

The fishing tool may include a first half and second half. The first half includes a first upper portion having a first inner surface, a first middle portion and a first handle. The second half includes a second upper portion having a second inner surface, a second middle portion and a second handle. The line trimming portion includes a block and a line trimming blade and the block is positioned on one of the first handle and the second handle and the line trimming blade is positioned on the other of the first handle and the second handle, whereby moving the first handle in the direction of the second handle moves the line trimming blade in the direction of the block such that a fishing line positioned between the blade and the block will be cut when the line trimming blade is pressed against the block. The one or more hook eyelet threading portions each includes a first channel defined by a first opening at one end and a second opening at the opposite end and a second channel passing between a third opening and a closed end, wherein the first channel and the second channel intersect, wherein a portion of the first channel and a portion of the second channel is formed in the first upper portion and a portion of the first channel and a portion of the second channel is formed in the second upper portion such that the first and second channels are formed when the first inner surface of the first upper portion and the second inner surface of the second upper portion are in contact.

The multipurpose fishing tool may include at least three, four or five of the following: a line cutting portion, a line trimming portion, a hook sharpening portion, an eyelet cleaning portion, and one or more hook eyelet threading portions.

In another aspect the invention is directed to a method of using the multipurpose fishing tool described above. The method includes providing the multipurpose fishing tool comprising a first half and a second half joined together by a hinge mechanism, wherein the first half includes a first upper portion having a first inner surface, a first middle portion and a first handle and the second half includes a second upper portion having a second inner surface, a second middle portion and a second handle and performing at least two of the following steps using the multipurpose fishing tool:
squeezing the first handle and the second handle towards each other whereby the first inner surface and the second inner surface are separated, passing a fishing rod between the first and second inner surfaces and releasing the first and second handles to clamp the fishing tool onto the fishing rod or a handle of the fishing rod;
sliding the eyelet of a hook over a sharp end of a pin;
pulling a fishing line through an opening in the line cutting tool against a blade within the line cutting tool to cut fishing line;
threading the free end of a fishing line through the eyelet by squeezing the handles towards each other until the upper portions separate and expose the first and second channels and placing the eyelet of the hook in the second channel such that the eyelet is co-extensive with the first channel and passing the free end of the fishing line through a first opening into the first channel and advancing the line until it passes through the eyelet and out of the second opening into the first channel, squeezing the handles towards each other until the upper portions separate and removing the eyelet of the hook from the second channel;
tying a knot to retain the fishing line to the hook whereby the knot comprises a free end of the fishing line extending from the knot, placing the free end of the fishing line between a block of a line trimming portion and a blade of the line trimming portion and compresses the handles towards each other, whereby free end portion of the fishing line is cut from the fishing line; and sharpening the tip of the fishing hook by rubbing the hook against a hook sharpening surface of the hook sharpening portion within a groove and/or adjacent to the groove.

In one embodiment the method consists of:
squeezing the first handle and the second handle towards each other whereby the first inner surface and the second inner surface are separated, passing a fishing rod between the first and second inner surfaces and releasing the first and second handles to clamp the fishing tool onto the fishing rod or a handle of the fishing rod; and
threading the free end of a fishing line through an eyelet of a fishing hook by squeezing the handles towards each other until the upper portions separate and expose the first and second channels and placing the eyelet of the hook in the second channel such that the eyelet is co-extensive with the first channel and passing the free end of the fishing line through a first opening into the first channel and advancing the line until it passes through the eyelet and out of the second opening into the first channel, squeezing the handles towards each other until the upper portions separate and removing the eyelet of the hook from the second channel.

### DESCRIPTION OF THE FIGURES

FIG. 1 is side view of a fishing tool taken from the eyelet cleaning side of the tool.

FIG. 2 is a side view of the fishing tool of FIG. 1 with the fishing tool rotated such that the eyelet cleaning side of the tool and a portion of a line cutting side of the tool are visible.

FIG. 3 is a side view of the fishing tool of FIG. 1 with the fishing tool rotated such that only the eyelet cleaning side of the tool is visible.

FIG. 4 is a view of the upper half of the fishing tool of FIG. 1 showing channels for inserting a fishing line through the eyelet of the fishing hook.

FIG. 5 is a side view of the fishing tool of FIG. 1 taken with the fishing tool rotated relative to FIG. 1 such that the opposite end of the tool is visible.

FIG. 6 is a side view of the fishing tool of FIG. 1 with the fishing tool rotated 180 degrees such that the line cutting side of the tool is visible.

FIG. 7 is a side view of the fishing tool of FIG. 6 with the fishing tool rotated such that the line cutting side of the tool and a portion of the eyelet cleaning side of the tool are visible.

FIG. 8 is a side view of the fishing tool of FIG. 1 with the fishing tool rotated such that only the line cutting side of the tool is visible.

FIG. 9 is a side view of the fishing tool of FIG. 1 with the fishing tool rotated such that only the line cutting side of the tool is primarily visible.

FIG. 10 is an end view of the fishing tool of FIG. 1 with the fishing tool oriented such that the tip of the needle is oriented away from the viewer.

FIG. 11 is an end view of the fishing tool of FIG. 1 with the fishing tool oriented such that the tip of the needle is oriented towards the viewer.

FIG. 12 is a top view of the fishing tool of FIG. 1 with the fishing tool oriented such that the line inserting openings are visible.

FIG. 13 is a bottom view of the fishing tool of FIG. 1 with the spring and rod visible.

FIG. 14 is an end view of the fishing tool of FIG. 1 showing the positions of the foam pads within the channel.

FIG. 15 is a flow chart illustrating use of the fishing tool.

FIG. 16 is a side view of a prior art fishing tool for threading a fishing hook.

FIG. 17 is a side view of an alternative embodiment of the fishing tool having a single groove for sharpening a fishing hook.

FIG. 18 is a side view of the alternative embodiment of the fishing tool having a single groove for sharpening a fishing hook with the figure rotated relative to FIG. 17.

FIG. 19 is an end view of an alternative embodiment of the fishing tool having a single groove for sharpening a fishing hook and a line trimming component positioned at an end of the fishing tool.

FIG. 20 is a side view of the alternative embodiment of the fishing tool having a single groove for sharpening a fishing hook and a line trimming component position at an end of the fishing tool.

### DESCRIPTION OF THE INVENTION

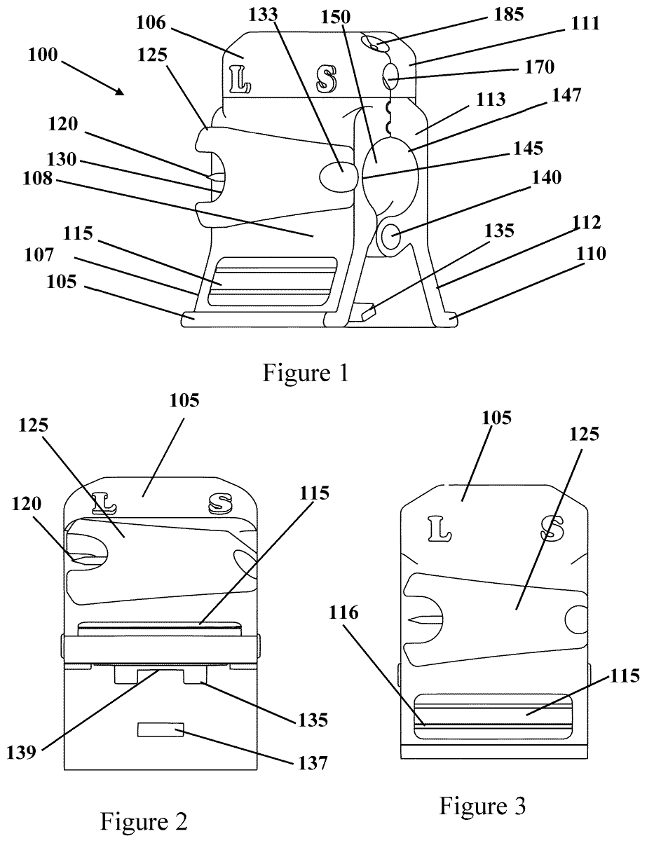

Referring to FIGS. 1-4, a fishing tool 100 has multiple components permitting an angler to (1) clamp the tool to a fishing rod, (2) thread a fishing line through a hook eyelet, (3) sharpen a hook, (4) open an eyelet, (5) cut a fishing line, and (6) trim a fishing line. The fishing tool 100 is made up of two halves or components 105, 110 with upper portions 106, 111, handles 107, 112, and middle portions 108, 113 positioned between the upper portions and the handles. By grasping the handles 107, 112 and compressing towards each other, both the upper portions 106, 111 and the middle portions 108, 113 are separated. As explained in more detail, simultaneously separating the upper and middle portions permits an angler to insert a fishing rod into the tool to secure the tool and also to insert a fishing hook eyelet into the tool for threading a fishing line through the eyelet.

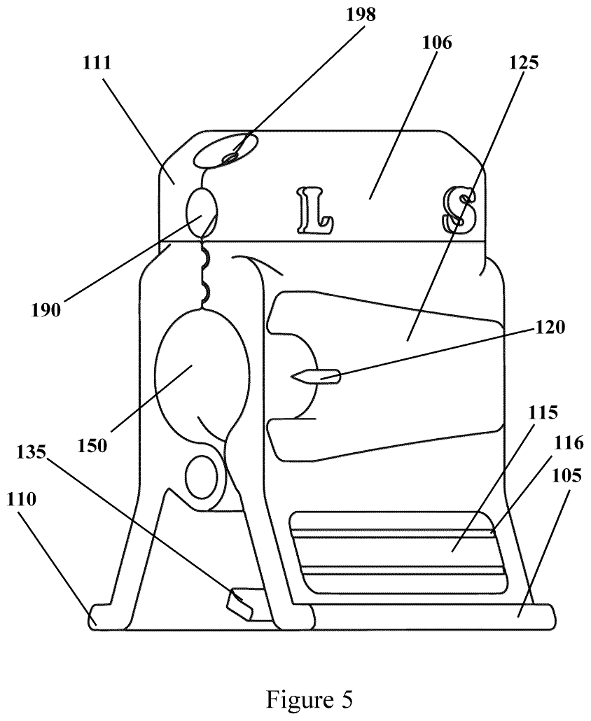

The first half 105 includes a surface 115 for sharpening a hook. The surface 115 is positioned within the handle 107. In one embodiment, the surface 115 may be in the form of a stone with one or more grooves 116. The stone can be a natural stone cut to fit onto the first half or a synthetic stone shaped to fit the first half. For example, the first half can include a rectangular cut out region in the handle portion 107 that the stone fits into and is adhered against using an adhesive. An angler takes a hook and can sharpen the hook tip by rubbing the tip against the stone and within a groove 116. FIG. 5 depicts the surface 115 as having a pair of grooves 116. Although the embodiment of FIG. 5 has two grooves, the tool may include a single groove 116 or more than two grooves 116.

The first half 105 also includes a needle or pin 120 having a sharpened end or tip mounted within a cover or enclosure 125. Hook eyelets may need to be cleaned if they are covered in dirt or ice. A newly purchased hook may have paint that obstructs the eyelet. The needle 120 is configured to be of a diameter of approximately 1 mm such that almost all hook eyelets can be cleaned by pressing against the sharpened tip. Other diameters of the needle can be used if desired. The needle 120 is mounted within a channel that firmly retains the needle within by an interference fit. In addition to the interference fit, the needle can be further retained by using an optional adhesive. The cover 125 is intended to enclose enough of the needle 120 such that an angler would be protected from the sharp tip during regular handling of the tool 100. The cover includes a cutout region 130 that is designed to permit the angler to easily slide the hook eyelet over the tip while also avoiding accidental impaling of the tip against the angler's finger. The cover 125 can be integrally molded on the first half 105 or be in the form of a separate piece that is adhered or fixed to the first half. The cover 125 has a longitudinal channel from a first opening 133 at one end to a second opening at the cutout region 130. The needle can be mounted within the cover by inserting the tip end into the first opening and pressing it through the channel until the tip 120 has passed through the second opening. Preferably the tip 120 will be about 0.25 mm to about 1 mm from the edge of the first half to prevent accidental nicking of the tip against a finger or other body part.

After tying a hook onto the fishing line the resulting knot will include a portion of fishing line extending from the hook eyelet and terminating in an end. That portion of fishing line typically is short, e.g., less than one inch in length, but it is desirable to trim off that portion of the fishing line. The tool 100 includes a mechanism to trim off such pieces of fishing line in the form of a blade mechanism. The first half 105 includes a first line trimming component 135 that interacts with a second line trimming component 137 on the second half 110. The first line trimming component 135 includes a sharp blade 139. The second line trimming component 137 is generally flat, such as in the form of a block, and made of a compliant material such that when the blade 139 is pressed against it, the blade will not be damaged. The angler places the short length of fishing line extending from the hook eyelet against the component 137 and squeezes the first half 105 and second half 110 against each other, which presses the blade 139 against the surface 137. The angler can try to cut off the free end of the fishing line as close as desirable to the eyelet in this manner. This arrangement permits the angler to easily trim off short lengths of fishing line adjacent to the hook.

The first half 105 is joined to the second half 110 by a spring hinge 140 that runs the length of the tool. The hinge 140 includes a rod 141 with a spring 142 mounted around the rod (see FIG. 13) that compresses the upper portions 106, 111 of each half 105, 110 against each other. By squeezing the handles 107, 112 of each half towards each other the upper portions are moved away from each other. Although a rod and spring configuration is disclosed, it should be understood that other hinge arrangements can be used.

The first half 105 and second half 110 are configured to each have a curved section 145, 147, respectively. When the upper halves 106, 111 are in compression against each other, the two curved sections form a channel 150. The channel 150 is of a diameter that permits the tool to be snugly clamped against the fishing rod or the handle of the fishing rod by squeezing the handles 107, 112 of the tool together to separate the upper halves. With the upper halves separated, the angler can insert the fishing rod or fishing rod handle through the separated upper halves and into the channel 150. Upon releasing the lower halves, the two curved sections 145, 147 are compressed against the rod or rod handle. By clamping the tool to the fishing rod or handle, the angler is able to easily use the tool for line threading, hook sharpening, eyelet cleaning, etc.

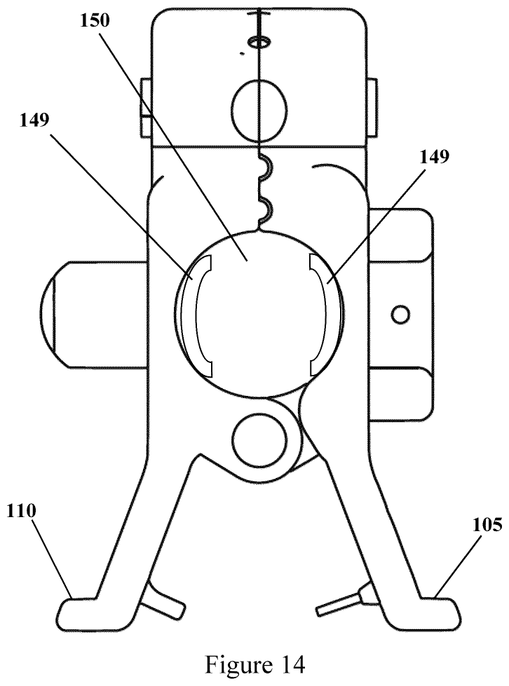

The inside surface of the channel 150 formed by the curved sections 145, 147 optionally includes foam pads 149 (FIG. 14) on opposite sides of the channel 150. The foam pads 149 are made of a soft material, such as a suitable thermoplastic elastomer, that deforms to conform to the surface of the rod when clamped onto the rod. The combination of the two halves 105, 110, spring hinge 140, foam pads 149 and channel 150, permits the angler to snugly clamp the tool 100 onto fishing rods of a variety of diameters. The foam pads 149 are selected to be of a sufficiently compliant material so that clamping onto a fishing rod does not damage the fishing rod, for example by scratching or nicking the surface of the fishing rod.

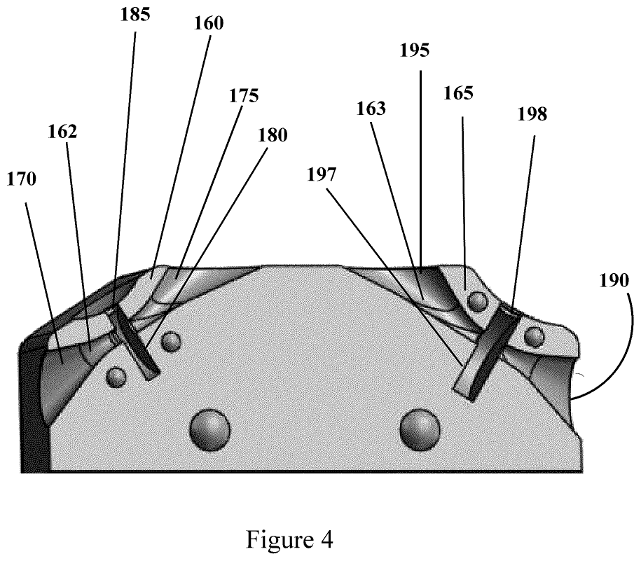

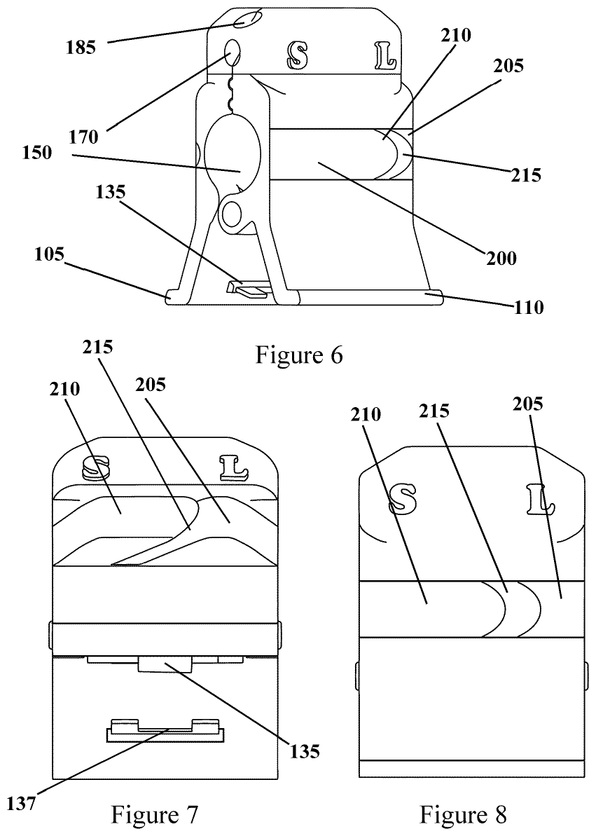

Referring also to FIG. 4, the tool 100 includes a line threading component that permits the angler to pass the fishing line through a hook eyelet. It is well known by anglers that it can be challenging to thread an eyelet in windy or cold conditions, on a rocking boat, or because of the challenges in seeing the small eyelet and threading the line through the eyelet. As seen in FIGS. 1 and 4, the upper portion of the tool includes two line threading components 160, 165. The first line threading component 160 includes a first opening 170 that opens to a first channel 162 that passes between the first opening 170 and a second opening 175. The channel 162 passing between the two openings is intersected by a second channel 180 that extends from an outer opening 185 to a terminus end within the tool. The second line threading component 165 includes a first opening 190 that opens to a channel that passes between the first opening 190 and a second opening 195. A channel 163 passing between the two openings is intersected by a second channel 197 that extends from an outer opening 198 to a terminus end within the tool. As seen in FIGS. 1, 5, 6 and 9 the upper portions 106, 111 each include raised lettering or other form of lettering to distinguish between the two line threading components 160, 165. Each component is configured to receive different sized hooks. The lettering can be in the form of a general lettering such as L for large hooks and S for small hooks.

To thread a hook in the first line threading component 160, the angler squeezes the handles 107, 112 to open the two upper halves to expose opposite sides of the channel 180 or 197. The angler then inserts the eyelet of the fishing hook into the channel 180 or 197 depending on the size of the hook and eyelet. Fishing hooks come in different sizes and, to accommodate different size hooks, the channels 180 and 197 are of different diameters. Assuming that the angler inserts the hook into the channel 180, the angler then inserts the end of the fishing line into the opening 170 or 175, into the channel, through the eyelet and out of the opposite opening 175 or 170. The angler then squeezes the two handles 107, 112 to open the two upper halves to remove the threaded hook from the channel 180 and ties the knot to retain the hook to the fishing line. The angler then uses the trimming tool 135, 137 to trim any excess line from the free end of the line from adjacent to the hook eyelet.

The fishing tool provides an advantage to anglers by providing the ability to thread hooks of different sizes because of the two different line threading components 160, 165. Further, because the line threading channels 162, 163 each intersect with only one other channel (i.e., channels 185 and 197, respectively), there is less likelihood of the line getting hung up in an interesting channel that does not include a hook eyelet. As seen in the figures, and in particular FIG. 4, the first opening 170 and the second opening 175 are positioned on perpendicular surfaces rather than parallel surfaces. In this manner the channel 162 runs diagonally through the fishing tool rather than horizontally through the tool. Similarly, in the line threading component 165, the first opening 190 and the second opening 195 are positioned on perpendicular surfaces rather than parallel surfaces. In this manner the channel 163 runs diagonally through the fishing tool rather than horizontally through the tool. By configuring the channels 162, 163 in this manner, the tool is configured to provide trouble-free threading of a fishing line through eyelets of different sizes.

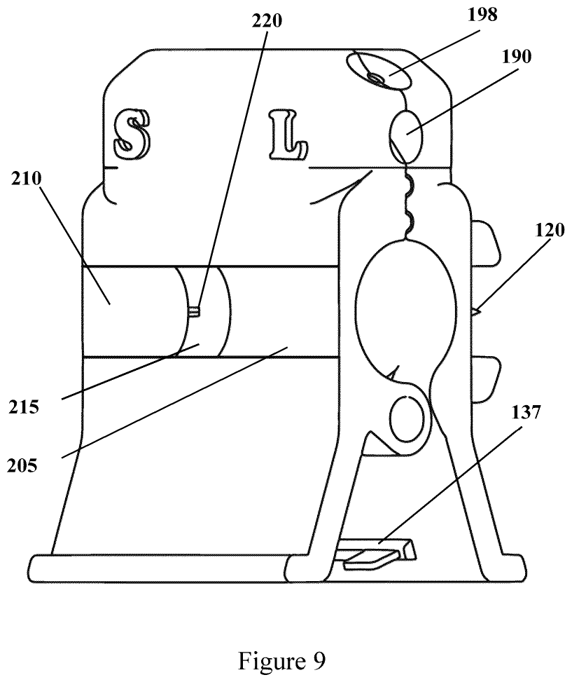

Referring to FIG. 5, the tool 100 also includes a line cutting tool 200 mounted on the second half 110 in the middle portion 112. The line cutting tool 200 includes a pair of ridges 205, 210 separated by a gap 215. A blade 220 (see FIG. 9) is positioned within the gap 215 between the ridges 205, 210 and oriented in a longitudinal direction parallel to the longitudinal channel 150. To use the line cutting tool 200, the angler grasps the fishing line and pulls it into the gap 215 against the blade 220. By applying force to the fishing line against the blade the angler is able to cut the line.

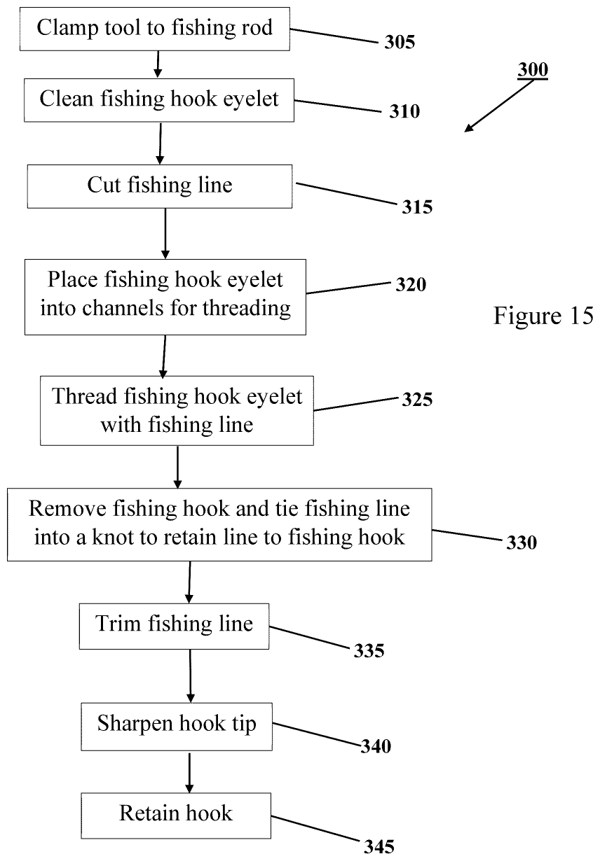

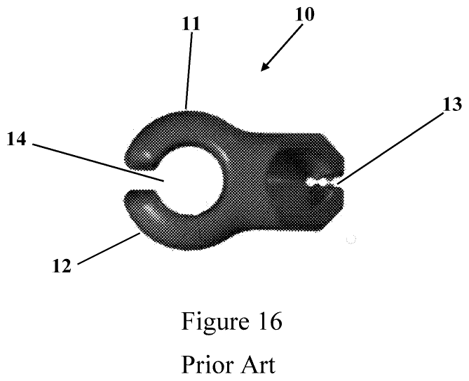

Referring to FIG. 15, in a process 300, to use the fishing tool 100 the angler first clamps the tool onto a fishing rod, such as the handle of the fishing rod. (Step 305) The angler grasps the lower handles 107, 112 and compresses them towards each other. This separates the upper portions 106, 111 such that the angler can pass the fish rod handle through the upper portions into the channel 150. Alternatively, the angler can pass the end of the fishing rod handle through one of the openings at the ends of the channel. The angler then gradually releases the compression of the lower handles 107, 112 such that the curved halves 145, 147 clamp against the fishing rod handle. If the foam pads 149 are present, the foam material will conform to fit the fishing rod handle and ensure the tool is tightly clamped to the handle.

Next, the angler examines the condition of the eyelet of the fishing hook to check for the presence of dirt, ice, paint, etc. that obscures the opening through the eyelet. To remove any material obstructing the eyelet or merely to ensure a clean opening, the angler slides the eyelet over the sharp end of the pin 120. (Step 310) With the eyelet cleaned and open, the angler then takes the fishing line and examines the end to ensure that its condition is still good. If the angler finds there to be damage to the fishing line, the angler then pulls the line through the opening 215 against the blade in the line cutting tool 200, cutting away the damaged portion of the fishing line. (Step 315).

With the hook eyelet prepared and the fishing line prepared, the angler can then thread the fishing line through the eyelet. The angler grasps and compresses the handles 107, 112 towards each other until the upper portions 106, 111 separate, exposing the channels 180, 197. Depending on the size of the hook, the angler can insert the eyelet end of the fishing hook into the appropriate channel 162, 163. (Step 320) With the eyelet in place, the angler releases the lower handles so that the upper portions come together and secure the fishing hook. The angler then passes the end of the fishing line through the opening 170 or the opening 190 and feeds it through the eyelet. (Step 325) The angler next compresses the lower handles towards each other and removes the threaded hook.

With the hook threaded, the angler then ties a knot to retain the fishing line to the hook. (Step 330) A threaded hook can have a short end of fishing line extending from the knot. The short end of the fishing line, depending upon its length, can be undesirable and the angler may want to remove that short end. The fishing tool 100 includes the line trimming portion 135, 137 at the handles. The angler inserts the short end between the block 137 and blade 139 and compresses the handles towards each other, thereby cutting off that free end portion of the fishing line. (Step 335).

With the fishing hook appropriately tied to the fishing line and the line trimmed, the angler can examine the tip of the hook for sharpness. If the tip is not sufficiently sharp, the angler can sharpen the tip by rubbing it against the hook sharpening portion 115 and within a groove 116. (Step 340) The angler then can start fishing by, for example, baiting the hook and casting the hook. Alternatively, if the angler needs to take care of another task, the angler can place the tip end of the hook into the opening 133 and tighten the line to ensure the hook remains in place. (Step 345) The angler will then not need to be concerned that the hook can snag another object.

Variations of the process 300 depicted in FIG. 15 are possible. For example, an angler might not need to cut the fishing line, sharpen the hook or trim the end of the fishing line. In such a situation, which is expected to be quite typical, the angler only needs to thread the fishing line through a hook eyelet. In such a situation, the angler squeezes the handles 107, 112 towards each other until the upper portions 106, 111 separate, exposing the channels 180, 197 and the channel 150. The angler positions the fishing rod or handle within the channel 150 and a hook eyelet into one of the channels 180, 197. The angler then releases the handles 107, 112 such that the upper portions 106, 111 are again in contact. The ability to mount the fishing tool to the fishing rod and an eyelet within one of the channels 180, 197 with just one action (squeezing the handles 107, 112 and then releasing the handles) is believed to be a unique feature found only in the fishing tool 100.

This unique feature is a result of the position of the channel 150 and the channels 180, 197 (along with channels 162, 163) being on the same side of the springe hinge 140. Referring to the illustrations in FIGS. 1 and 5, each half 105, 110 is joined at the spring hinge 140 and pivots around the spring hinge. By squeezing the handles 107, 112 together, all features positioned on the same side of each half 105, 110 that are on the other side of the spring hinge 140 will move together when the handles are squeezed together. Therefore, in one embodiment, both the first halves 105, 110 include along their length a spring hinge mechanism approximately halfway along its length. The spring hinge mechanism is positioned perpendicularly to the length of the first half. On one side of the hinge is the handle. On the other side of the hinge are concave regions for the channels that receive the fishing rod, hook eyelet and fishing line. When the two halves 105, 110 are pressed together under the force of the spring hinge, the opposite concave regions form the various channels for receiving the fishing rod, hook eyelet and fishing line.

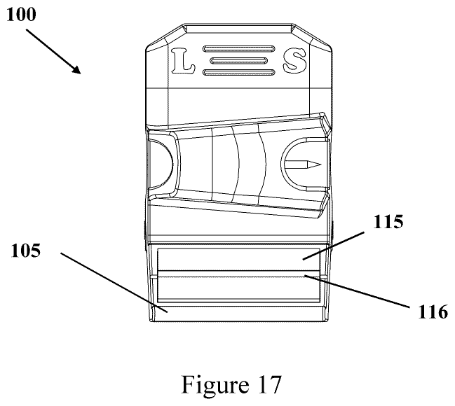

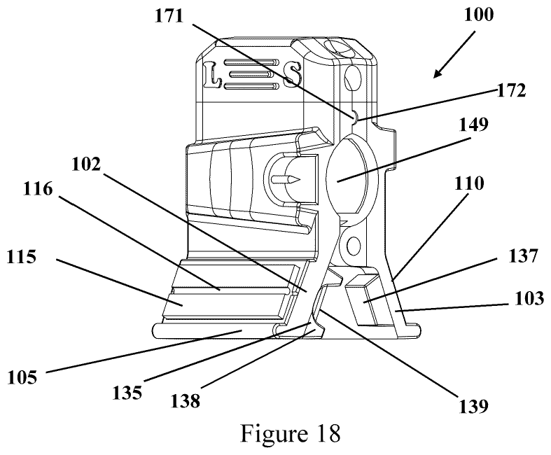

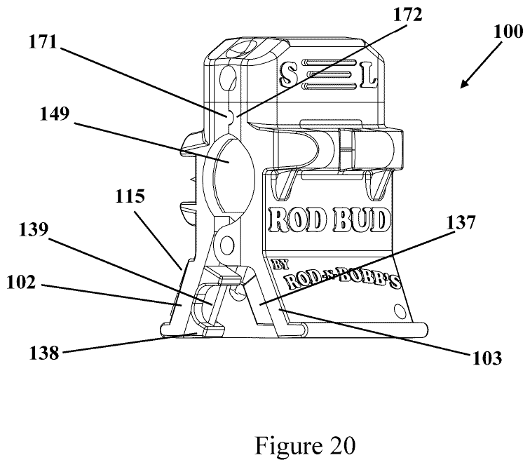

Referring to FIGS. 17-20, modifications to the fishing tool 100 are within the scope of the invention. For example, FIGS. 17 and 18 show the hook sharpening surface 115 as including a single groove 116 for sharpening a hook. As noted above, the surface 115 may have one groove or more than one groove 116, e.g., two grooves, three grooves, etc.

Referring to FIGS. 18-20, the fishing tool may be further modified to move the position and/or the orientation of the line trimming components 135, 137. For example, FIGS. 2, 6, 7 and 9 illustrate the line trimming components 135, 137 as being approximately midway between the opposite ends of the components 105, 110. In another embodiment, the line trimming components may be placed at an end 102 of the components 105, 110. This positioning is made clear in FIG. 18. The cutting blade 139 is mounted within a frame 138 and positioned on the first component 105 adjacent to end 102 of the first component. The block 137 is positioned on the second component 110 adjacent to the corresponding end 103 of the second component. In this manner, when the handles are squeezed toward each other, the cutting blade 139 will move in the direction of the block 137. The first and second handles can be squeezed toward each other such that the blade and block connect and can trim any fishing line placed between the two. The positioning of the blade 139 and the block 137 in FIGS. 18-20 at the ends 102, 103 of the first and second components provides an advantage to an angler who can more easily manipulate the fishing line and hook to permit easy trimming of the line.

The orientation of the block 137 and blade 139 illustrated in FIGS. 18-20 also differs from the orientation of the block and blade in FIGS. 2, 6, 7 and 9. Specifically, the block 137 and blade 139 have been rotated by approximately 90 degrees in the two figures. This modification of the orientation provides an advantage to angler because it can be easier to manipulate the fishing line and hook to permit easy trimming of ends of the line adjacent to the hook.

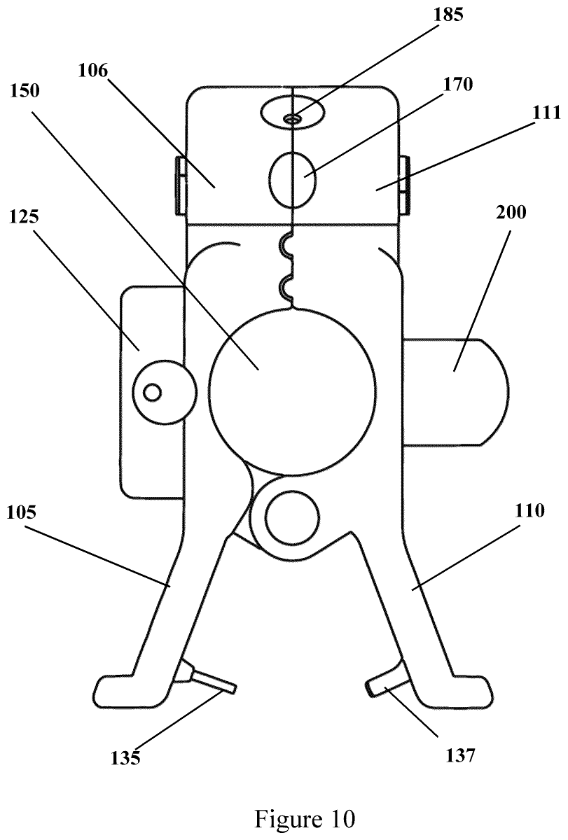

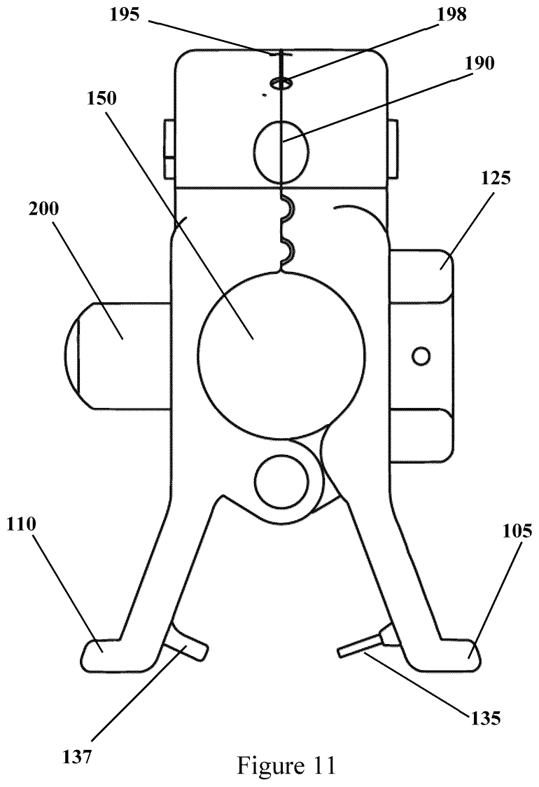

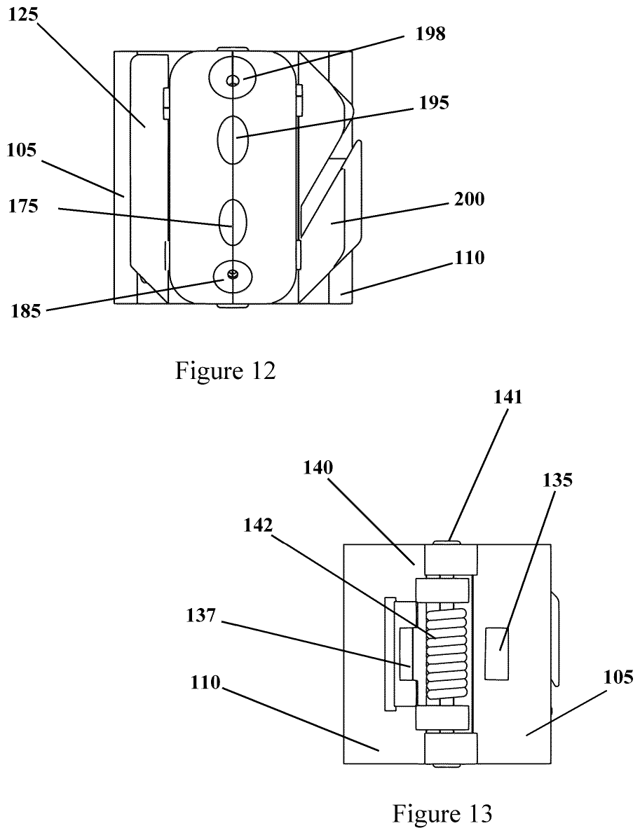

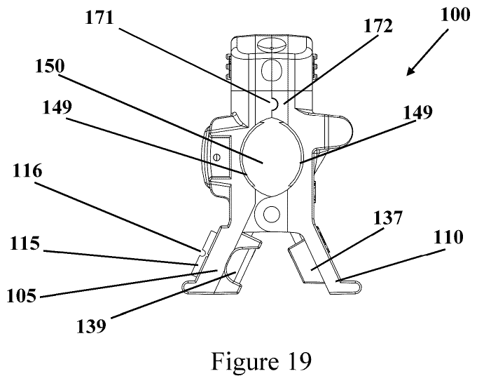

The configuration of the channel 150 illustrated in FIGS. 18-20 differs slightly from the configuration of the channel 150 illustrated in, for example, FIGS. 10, 11, 14. Notably, FIGS. 10, 11 and 14 illustrate the channel 150 as being completely or almost completely round. As most easily seen in FIG. 19, the channel 150 is generally oval, i.e., has an oval cross-section or its circumference forms an oval cross-section. As advantage of the oval cross-section seen in FIG. 19 is that when squeezing the handles 105, 110, the opening between the opposite halves of the upper portion will be enlarged compared to a round opening having the same diameter. This eases the ability of an angler to pass the fishing rod into the channel 150.

FIGS. 18-20 also illustrate another feature of the fishing tool that ensures proper alignment of the two halves 105, 110 to ensure accurate formation of channels 150, the channels 180, 197 and the channels 162, 163 when the upper portions 106, 111 are pressed together. The first half 105 includes a convex ridge 171 that mates with a concave groove 172 in the second half 110. When the upper portions are pressed together, the ridge 171 fits within the groove 172, ensuring alignment of the opposite halves of the tool. The upper portion can include additional combinations of grooves and ridges to ensure proper alignment. The grooves and ridges can be of any length, or can be shortened and modified to be in the form of convex bumps and concave depressions that mate together to ensure proper alignment (e.g., FIG. 4).

The fishing tool can be made of a plastic material by, for example, injection molding. Suitable plastic materials include nylon and thermoplastic elastomers. For example, in one embodiment the handles 107, 112 and middle portions 108, 113 can be made of a rigid plastic such as nylon. The upper portions 106, 111 can be made of a more compliant plastic such as a thermoplastic elastomer. In addition to the upper portions, the inner surface of the channel 150 can be made of the compliant plastic. For example, the inner surface or pads 149 can be made of the compliant plastic. The fishing tool can be made with these features by injection molding with nylon to form the handles and middle portions followed by injection molding with the compliant thermoplastic elastomer to form the inner surface or pads along with the upper portions. The thermoplastic elastomer is injected in a channel through the nylon in the handles and middle portion and into regions in the die to form upper portions and then forms the inner surface or pads. In another embodiment, the order of injection molding can be reversed. Examples of suitable thermoplastic elastomers include styrenic block copolymer, some thermoplastic olefinic elastomers, some thermoplastic polyester elastomers, thermoplastic vulcanizate, some thermoplastic amide elastomers, and some thermoplastic polyurethane elastomers.

It should be understood that a number of unique combinations of features are disclosed herein and the invention is intended to include them all. For example, one unique combination is provided by a fishing tool that includes the two halves joined by a spring hinge mechanism and includes the curved regions that forms the channel to receive the fishing rod, the channels to receive the hook eyelets and the channels to receive the fishing line for threading through the eyelets. Another group of unique combinations is provided by a fishing tool that includes the two halves joined by a spring hinge mechanism and includes the curved regions that form the channel to receive the fishing rod and additionally includes one or more of a line cutting feature, a line trimming feature, a hook sharpening feature and an eyelet cleaning feature.

An additional feature of the fishing tool 100 includes a component to ensure that if the tool falls in the water while fishing, the tool will not sink and be lost. The component consists of a float and a means of connecting the float to the tool. For example, one portion of the tool, such as the handle 105 or the handle 110, may include an opening in which an O-ring can be mounted. The float may include a cord with a clip mechanism for clipping onto the O-ring. The float may be of a variety of shapes, including a tubular shape. The float may be hollow to more easily float or may be made of a buoyant material. As an additional feature, the float may be configured to include a flashlight or may be configured to have a channel for receiving a flashlight.

In another embodiment, the fishing tool can include a flashlight built into the tool. For example, the body of the tool (e.g., one or both of the two halves 105, 110) can be configured to include a flashlight. The flashlight can be on an outer surface of one or the other halves, on an inner surface of one or the other halves, or with the body between the outer surface and the inner surface of one or the other halves. For example, the flashlight can be on an outer surface adjacent to the eyelet cleaning portion 125, adjacent to the fish hooking sharpening portion 115, adjacent to the fishing line cutting portion 200, or adjacent to the eyelet threading portion. In another embodiment, the flashlight can be adjacent to the line trimming portion between the handles 105, 110, and run the length of the handles. The flashlight also can be within the body of the tool (e.g., within a channel or recessed volume) wherever there is enough width and height to accommodate a flashlight, in particular a battery and a LED light bulb.

In another embodiment, each of the handles 107, 112 of the tool 100 can be modified to include a blade in a configuration such that compressing the handles towards each other causes the two blades to function as scissors. The handle 107 can include a first scissor blade and the handle 112 can include a second scissor blade. The first scissor blade is positioned on an inside surface of the handle on an end opposite the end 102. The second scissor blade is positioned on an inside surface of the handle on an end opposite the end 103. In this manner, when the handles are squeezed toward each other, the first scissor blade and the second scissor blade will move towards each other. The first and second handles can be squeezed toward each other such that the first and second scissor blades slide past each other to function as scissors. The scissor blades can be serrated or smooth as desired.

What is claimed is:

1. A multipurpose fishing tool comprising a clamping portion comprising a hinge to clip onto a fishing rod and at least one of the following:
a line cutting portion;
a line trimming portion;
a hook sharpening portion;
an eyelet cleaning portion; and
one or more hook eyelet threading portions,
wherein the clamping portion, the line cutting portion, the line trimming portion, the hook sharpening portion, the eyelet cleaning portion, and the hook eyelet threading portion are each a different portion from the other.

2. The multipurpose fishing tool of claim 1, wherein the hook sharpening portion comprises a sharpening surface.

3. The multipurpose fishing tool of claim 2, wherein the sharpening surface further comprises a groove.

4. The multipurpose fishing tool of claim 1, wherein the hook eyelet cleaning portion comprises a prong or needle having an end configured to be inserted within an eyelet of a hook.

5. The multipurpose fishing tool of claim 4, wherein at least a portion of the prong or needle is positioned within an enclosure.

6. The multipurpose fishing tool of claim 1, wherein the line cutting portion comprises a line cutting blade.

7. The multipurpose fishing tool of claim 6, wherein the line cutting portion comprises a groove enclosed on at least two sides and the line cutting blade is positioned within the groove, whereby a user of the fishing tool is protected from injury by the line cutting blade.

8. The multipurpose fishing tool of claim 1, wherein the fishing tool comprises a first half and a second half joined together by the hinge.

9. The multipurpose fishing tool of claim 8, wherein the eyelet cleaning portion and the hook sharpening portion are positioned on the first half and the line cutting portion is positioned on the second half.

10. The multipurpose fishing tool of claim 8, wherein the line trimming portion comprises a block and a line trimming blade and the block is positioned on one of the first half and the second half and the line trimming blade is positioned on the other of the first half and the second half.

11. The multipurpose fishing tool of claim 8, wherein:
the first half comprises a first upper portion, a first middle portion and a first handle;
the second half comprises a second upper portion, a second middle portion and a second handle; and
the line trimming portion comprises a block and a line trimming blade and the block is positioned on one of the first handle and the second handle and the line trimming blade is positioned on the other of the first handle and the second handle,
whereby moving the first handle in the direction of the second handle moves the line trimming blade in the direction of the block such that a fishing line positioned between the blade and the block will be cut when the line trimming blade is pressed against the block.

12. The multipurpose fishing tool of claim 8, wherein:
the first half comprises a first upper portion with a first inner surface, a first middle portion and a first handle;
the second half comprises a second upper portion with a second inner surface, a second middle portion and a second handle; and
one or more hook eyelet threading portions, wherein each eyelet portion comprises a first channel defined by a first opening at one end and a second opening at the opposite end and a second channel passing between a third opening and a closed end, wherein the first channel and the second channel intersect,
wherein a portion of the first channel and a portion of the second channel is formed in the first upper portion and a portion of the first channel and a portion of the second channel is formed in the second upper portion such that the first and second channels are formed when the first inner surface of the first upper portion and the second inner surface of the second upper portion are in contact.

13. The multipurpose fishing tool of claim 12, wherein the hinge is positioned in the first handle and the second handle, or adjacent to the first handle and the second handle, and the first upper portion and the second upper portion are on opposite sides of the first half and the second half, respectively, relative to the hinge compared to the first handle and the second handle.

14. The multipurpose fishing tool of claim 8, wherein
the first half comprises a first upper portion with a first inner surface, a first middle portion with a third inner surface and a first handle, wherein the third inner surface is concave and forms a semicircle;
the second half comprises a second upper portion with a second inner surface, a second middle portion with a fourth inner surface and a second handle wherein the fourth inner surface is concave and forms a semicircle; and
when the first inner surface is in contact with the second inner surface the third inner surface and the fourth inner surface form and define a lengthwise channel passing from a first opening at a first end of the fishing tool to a second opening at a second, opposite end of the fishing tool, whereby the lengthwise channel is configured to retain a fishing rod or a fishing rod handle.

15. The multipurpose fishing tool of claim 14, wherein the hinge is positioned in the first handle and the second handle, or adjacent to the first handle and the second handle, and the first upper portion and the second upper portion are on opposite sides of the first half and the second half, respectively, relative to the hinge compared to the first handle and the second handle.

16. The multipurpose fishing tool of claim 14, wherein the lengthwise channel has an oval cross-section.

17. A multipurpose fishing tool having a butterfly clip configured to clip onto a fishing rod and comprising at least two of the following:
a line cutting portion;
a line trimming portion;
a hook sharpening portion;
an eyelet cleaning portion; and
one or more hook eyelet threading portions,
wherein the line cutting portion, the line trimming portion, the hook sharpening portion, the eyelet cleaning portion, and the one or more hook eyelet threading portions are each a different portion from the other.

18. The multipurpose fishing tool of claim 17, wherein:
the hook eyelet cleaning portion comprises a prong or needle having an end configured to be inserted within an eyelet of a hook and at least a portion of the prong or needle is positioned within an enclosure;
the line cutting portion comprises a groove enclosed on at least two sides and a line cutting blade is positioned within the groove, whereby a user of the fishing tool is protected from injury by the line cutting blade;
the hook sharpening portion comprises a sharpening surface and the sharpening surface comprises at least one groove; and
the hook eyelet cleaning portion comprises a prong or needle having an end configured to be inserted within an eyelet of a hook.

19. The multipurpose fishing tool of claim 17, wherein the fishing tool comprises a first half and second half and
the first half comprises a first upper portion having a first inner surface, a first middle portion and a first handle;
the second half comprises a second upper portion having a second inner surface, a second middle portion and a second handle;
the line trimming portion comprises a block and a line trimming blade and the block is positioned on one of the first handle and the second handle and the line trimming blade is positioned on the other of the first handle and the second handle, whereby moving the first handle in the direction of the second handle moves the line trimming blade in the direction of the block such that a fishing line positioned between the blade and the block will be cut when the line trimming blade is pressed against the block; and
the one or more hook eyelet threading portions each comprises a first channel defined by a first opening at one end and a second opening at the opposite end and a second channel passing between a third opening and a closed end, wherein the first channel and the second channel intersect, wherein a portion of the first channel and a portion of the second channel is formed in the first upper portion and a portion of the first channel and a portion of the second channel is formed in the second upper portion such that the first and second channels are formed when the first inner surface of the first upper portion and the second inner surface of the second upper portion are in contact.

20. A method of using the multipurpose fishing tool of claim 1, the method comprising providing the multipurpose fishing tool comprising a first half and a second half joined together by a hinge mechanism, wherein the first half comprises a first upper portion having a first inner surface, a first middle portion and a first handle and the second half comprises a second upper portion having a second inner surface, a second middle portion and a second handle and performing at least two of the following steps using the multipurpose fishing tool:
squeezing the first handle and the second handle towards each other whereby the first inner surface and the second inner surface are separated, passing a fishing rod between the first and second inner surfaces and releasing the first and second handles to clamp the fishing tool onto the fishing rod or a handle of the fishing rod;
sliding the eyelet of a hook over a sharp end of a pin;
pulling a fishing line through an opening in the line cutting tool against a blade within the line cutting tool to cut fishing line;
threading the free end of a fishing line through the eyelet by squeezing the handles towards each other until the upper portions separate and expose the first and second channels and placing the eyelet of the hook in the second channel such that the eyelet is co-extensive with the first channel and passing the free end of the fishing line through a first opening into the first channel and advancing the line until it passes through the eyelet and out of the second opening into the first channel, squeezing the handles towards each other until the upper portions separate and removing the eyelet of the hook from the second channel;
tying a knot to retain the fishing line to the hook whereby the knot comprises a free end of the fishing line extending from the knot, placing the free end of the fishing line between a block of a line trimming portion and a blade of the line trimming portion and compresses the handles towards each other, whereby free end portion of the fishing line is cut from the fishing line; and
sharpening the tip of the fishing hook by rubbing the hook against a hook sharpening surface of the hook sharpening portion within a groove and/or adjacent to the groove.

21. The method of claim 20, wherein the method consists of
squeezing the first handle and the second handle towards each other whereby the first inner surface and the second inner surface are separated, passing a fishing rod between the first and second inner surfaces and releasing the first and second handles to clamp the fishing tool onto the fishing rod or a handle of the fishing rod; and
threading the free end of a fishing line through an eyelet of a fishing hook by squeezing the handles towards each other until the upper portions separate and expose the first and second channels and placing the eyelet of the hook in the second channel such that the eyelet is co-extensive with the first channel and passing the free end of the fishing line through a first opening into the first channel and advancing the line until it passes through the eyelet and out of the second opening into the first channel, squeezing the handles towards each other until the upper portions separate and removing the eyelet of the hook from the second channel.
